(19) United States
(12) Patent Application Publication
(10) Pub. No.: US 2002/0068550 A1
(43) Pub. Date: Jun. 6, 2002

(54) Method and apparatus for obtaining telephone numbers

(76) Inventor: Luis Tejada, Baldwin, NY (US)

Correspondence Address: OSTROLENK FABER GERB & SOFFEN, 1180 AVENUE OF THE AMERICAS, NEW YORK, NY, 100368403

(21) Appl. No.: 09/730,134

(22) Filed: Dec. 5, 2000

(51) Int. Cl. H04M 3/42; H04B 1/06; H04B 1/66; H04M 11/10

(52) U.S. Cl. 455/414; 455/412; 455/201

(57) ABSTRACT

A method and system for selectively providing information concerning wireless phone numbers maintain a database which identifies the wireless phone numbers of a group of persons listed in the database and, for each such wireless phone number, maintain a profile indicating a set of conditions under which the wireless phone number can be provided to third parties. Requests for wireless phone numbers of persons in the group are received from third parties. The wireless phone numbers are provided to the third party if a set of conditions associated with that wireless phone number have been met.

### BACKGROUND OF THE INVENTION

The present invention is directed towards a method and apparatus for obtaining wireless (e.g., cellular, PCS beeper and satellite) telephone numbers.

Wireless phones are becoming an increasingly significant part of everyday business and personal life. What was once a novelty has become an integral part of commercial and personal communications. Many individuals are using wireless phones as their primary means of telephone communication and some individuals are foregoing land line connections totally in favor of wireless communications.

While the number of wireless phones is increasing exponentially, and the importance of contacting an individual on his or her wireless phone is becoming ever more critical, wireless phone numbers remain unlisted. This creates significant problems.

Most businessmen and women carry cell phones so that they can be in constant touch with their business associates, customers, clients, etc. If any of these third parties do not know (or have misplaced) the individual's wireless phone number, they cannot reach him. This could result in significant loss of business opportunities.

Similarly, many individuals carry wireless phones so that they can be contacted in emergencies by friends and family members. If a friend or family member does not know (or has misplaced) the individual's wireless phone number, he or she has no way of obtaining it and cannot contact the individual.

### BRIEF DESCRIPTION OF THE INVENTION

The present invention is intended to overcome the foregoing drawbacks of the prior art by providing a listing of wireless phone numbers which will be made available to the public. However, it is recognized that there are circumstances under which access to these phone numbers should be restricted. For this reason, several options can be provided for minimizing access to these phone numbers. One is to simply request that the service provider treat the wireless phone number as an unlisted number. This can be done either free of charge or with an appropriate charge to the customer. Alternatively, the customer can provide a restricted list of individuals to whom his phone number should be provided. For example, the customer could list members of his family and friends whom he would like to have access to his phone number. A business customer can list the individual members of his company, or even a general class of individuals (i.e., employees of ABC Company) who would have access to his phone number.

The present invention is directed towards a method of selectively providing information concerning wireless phone numbers, the method comprising:

maintaining a database which identifies the wireless phone numbers of a group of person listed in the database and for each such wireless phone number maintaining a profile indicating a set of conditions under which the wireless phone number can be provided to third parties;

receiving a request from a third party for the wireless phone number of a person in the group; and

providing the wireless phone number of the person requested to the third party if the set of conditions associated with that wireless phone number have be en met.

The database can be a single integrated database or can be a plurality of related databases. The condition associated with each number is preferably either that is published, in which case the wireless phone number will be given only to any third party making the request, unpublished, in which case the wireless phone number will not be given to any third party making the request, or restricted, in which case the wireless phone number will be given only to third parties requesting the phone number who meet certain predefined requirements. For example, parties to whom the wireless phone number can be provided may be a specified list of individuals or a list of one or more organizations (in which case the wireless phone number will be provided only to individuals associated with the organization(s)).

### BRIEF DESCRIPTION OF THE DRAWING(S)

For the purpose of illustrating the invention, there is shown in the drawing a form which is presently preferred, it being understood, however, that the invention is not limited to the precise arrangement and instrumentality shown.

FIG. 1 is a block diagram showing a telephone network connected to a system for selectively providing information concerning wireless phone numbers in accordance with a presently preferred embodiment of the present invention.

FIG. 2 illustrates the logical structure of a database preferably used in accordance with the present invention.

FIG. 3 is a flowchart showing the process carried in accordance with the presently preferred embodiment of the present invention.

### DETAILED DESCRIPTION OF EMBODIMENTS OF THE INVENTION

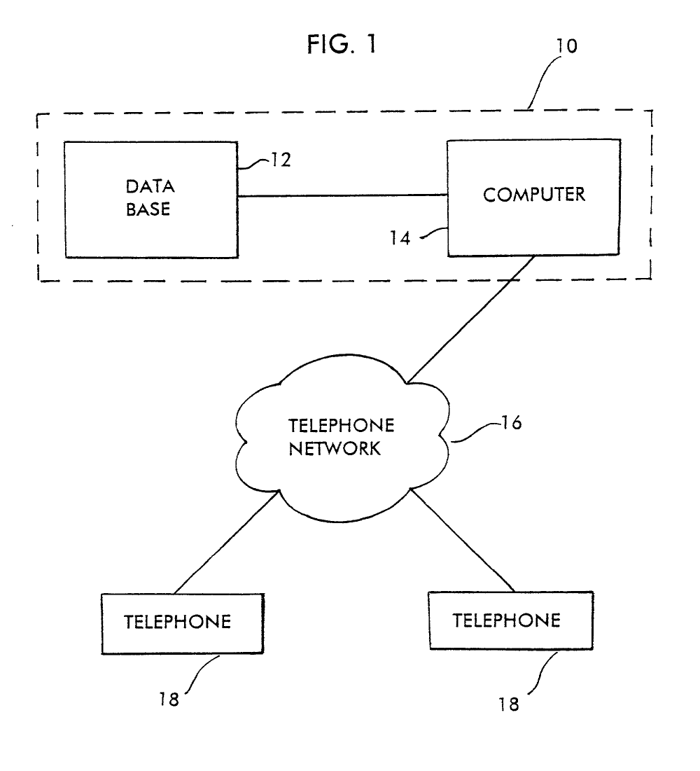

Referring now to the drawings wherein like numerals indicate like elements, there is shown in FIG. 1 a system for selectively providing information concerning wireless phone numbers constructed in accordance with the principles of the present invention and designated generally as 10. The system 10 includes a database 12 and a computer 14. The computer 14 can be a single centralized computer or can be a plurality of computers located at one location or distributed over various geographical areas.

The database 12 stores information concerning the wireless phone numbers of a group of persons listed in the database and, for each such wireless phone number, maintains a profile indicating a set of conditions in which the wireless phone number can be provided to third parties. The database 12 can be a single-integrated database or a plurality of related databases (which can be located in a single location or can be distributed over a plurality of locations).

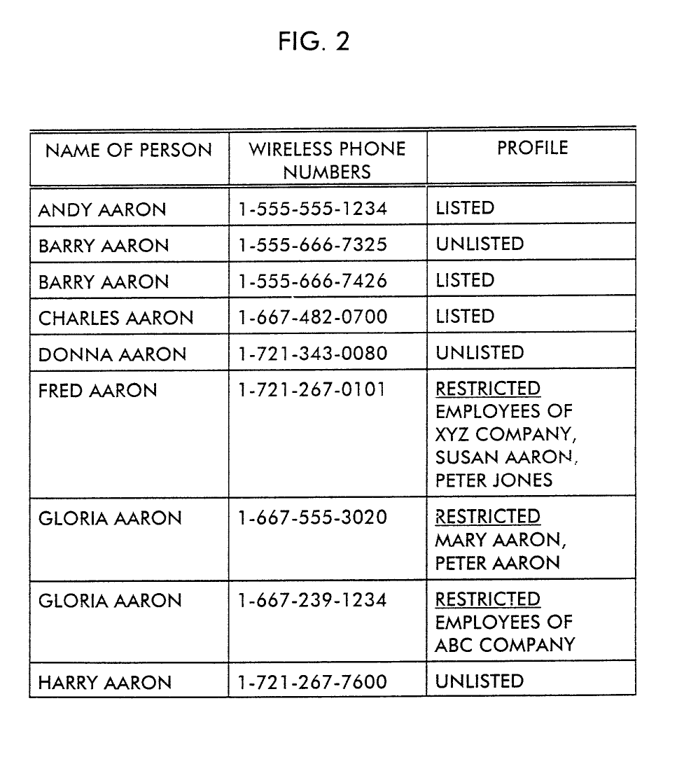

The relational structure of database 12 is shown, by way of example, in FIG. 2. Only a small portion of what would normally be a very large database is shown. The listings of several individuals with the last name of Aaron are shown. Barry Aaron has two different wireless phone numbers, as does Gloria Aaron. The remaining individuals have a single wireless phone number. For each wireless phone number, the database stores a profile which indicates the conditions (if any) under which the wireless phone number will be give to a third party requesting that number. Any suitable conditions can be used. In the examples shown, there are three general classes of profiles:

1. Listed: Any third party can be provided the wireless phone number;

2. Unlisted: No third parties will be entitled to obtain the wireless phone number;

3. Restricted: A restricted group of individuals will be entitled to obtain the wireless phone number.

In the restricted category, the owner of the phone number provides the names of individuals, or classifications of groups of individuals, who will be provided with access to their wireless phone numbers. For example, Mr. Fred Aaron has indicated that he is willing to have his wireless phone number provided to any employees of XYZ Company, to his wife Susan Aaron and his friend, Peter Jones. Gloria Aaron has two wireless phone numbers. The first (1-667-555-3020) can only be provided to Mary Aaron and Peter Aaron. The second (1-667-239-1234) can be given to any employees of ABC company.

The database is preferably an electronic database stored on one or more electronic memories and is accessed electronically by computer 14. In the preferred embodiment, the computer 14 will access the database and determine the conditions (if any) under which the telephone number can be provided to the requesting party based upon the profile for the wireless phone number requested. This information can either be used by the computer itself to determine whether the person requesting the wireless phone number is entitled to receive it or, alternatively, the information can be provided to a human operator for that purpose. In the latter case, the computer will provide, for example, a computer screen output to the human operator indicating the conditions under which the requested phone number can be released. In this case, the human operator will determine whether or not the person requesting the number meets the conditions and, if so, will provide the number to the person requesting it.

In the preferred embodiment, the computer 14 itself will in this case include artificial intelligence which will enable it to obtain information from the third party (e.g., the third party's name) which will enable the computer to determine whether the third party meets the criteria associated with the wireless phone number in question. Computer 14 will preferably use simulated voice software to provide the wireless phone number to the third party if it determines that the third party meets the criteria in question.

The computer 14 can receive the requests for wireless phone numbers in any desired manner. The information could come in as a voice request (in which case the computer 14 will have voice recognition software) or as an electronic request such as an e-mail. Alternatively, the request will come in to a human operator who will use a keyboard or other input device to communicate the request to the computer 14. In the preferred embodiment, the requests are transmitted over a telephone network 16 (any communication network, such as the Internet, can be used) from a plurality of sources. In the embodiment illustrated, the requests are made by individuals utilizing telephones 18 or other appropriate communication devices.

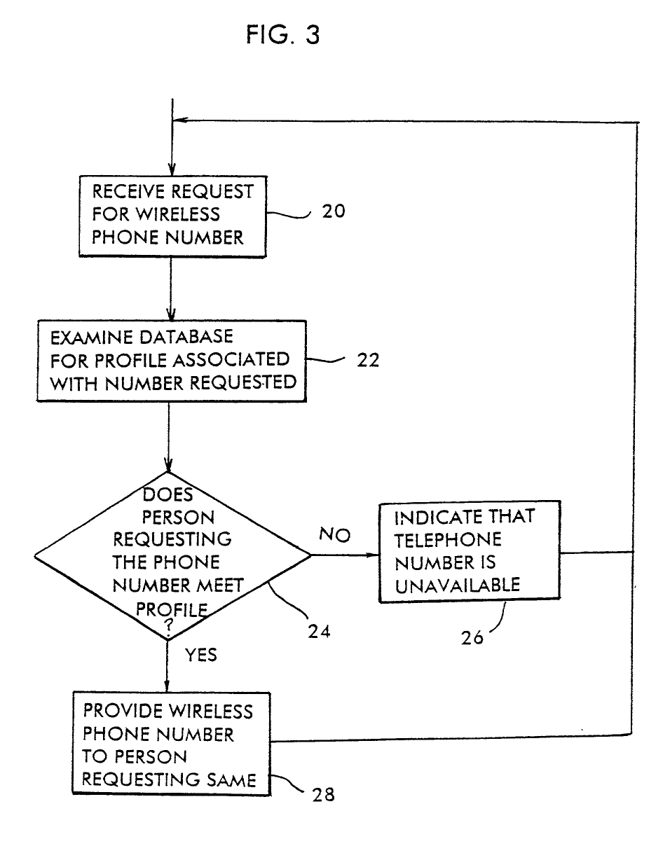

Upon receipt of a request for a wireless phone number, the process shown in FIG. 3 is preferably carried out. This process can be carried out automatically by the computer 14, can be carried out manually by human operators. Alternatively, it can be carried out by a combination of human operators and one or more computers.

The process starts at step 20 wherein the request for a wireless phone number is received. The information in database 12 is then examined to determine the profile associated with the wireless telephone number requested (Step 22). Thereafter, a determination is made as to whether the individual requesting the phone number meets the conditions of the profile (Step 24). If not, the individual is provided with an indication that the telephone number is unavailable (Step 26). The process then returns to Step 20. If the person requesting the phone number meets the requirements of the profile, he or she is provided with the wireless phone number requested (Step 28). The process then returns to Step 20.

While the preferred the embodiment shows the process as being linear, a parallel processing can also be used. For example, computer 14 (or alternatively a plurality of human operators, and/or a combination thereof) can receive a plurality of requests simultaneously and process them simultaneously.

Applying the foregoing process to the database shown in FIG. 2, the computer 14 may receive a request for the phone number of Barry Aaron. The computer will then examine the profiles for the two phone numbers for Barry Aaron and will determine that only the second phone number (1-555-666-7426) is a listed number. The computer will then provide that wireless phone number to the individual who had requested it. It will not provide the unlisted phone number (1-555-666-7325).

In a similar manner, if Ms. Mary Aaron called and requested the phone number of Gloria Aaron, she will have met the profile for the first phone number listed for Gloria Aaron (1-667-555-3020) and will be provided with that phone number. Assuming that Mary Aaron is not an employee of the ABC Company, she will not be provided with the second phone number listed (1-667-239-1234). In the preferred embodiment, Ms. Mary Aaron would have been either asked if she was an employee of ABC Company or simply asked what company she was an employee of in order that a determination could be made as to whether she met the conditions of the profile of the second phone number listed for Gloria Aaron.

If desired, the persons listed in the database 12 can be required to pay special fees for profiling their telephone numbers as either unlisted or restricted.

As used herein, the term “person” includes both individuals, corporations, partnerships and other legal entities.

The present invention may be embodied in other specific forms without departing from the spirit or essential attributes thereof and, accordingly, reference should be made to the appended claims, rather than to the foregoing specification, as indicating the scope of the invention.

What is claimed is:

1. A method for selectively providing information concerning wireless phone numbers, the method comprising:
maintaining a database which identifies the wireless phone numbers of a group of persons listed in the database and for each such wireless phone number maintaining a profile indicating a set of conditions under which the wireless phone number can be provided to third parties;
receiving a request from a third party for the wireless phone number of a person in the group; and
providing the wireless phone number to the third party if the set of conditions associated with that wireless phone number have been met.

2. The method of claim 1, wherein the database is a single integrated database.

3. The method of claim 1, wherein the database is formed from a plurality of related databases.

4. The method of claim 1, wherein at least one of the conditions is that the phone number is published, in which case the wireless phone number will be given to any third party making the request, and at least one other of the conditions is that the phone number is unpublished, in which case the wireless phone number will not be given to any third party making the request.

5. The method of claim 4, wherein at least one of the sets of conditions is that there is a restricted group of third parties to whom the phone number may be provided.

6. The method of claim 1, wherein at least one of the sets of conditions is that there is a restricted group of third parties to whom the phone number may be provided.

7. The method of claim 6, wherein the restricted group is a list of one or more individuals.

8. The method of claim 5, wherein the restricted group is a list of one or more individuals.

9. The method of claim 5, wherein the restricted group is a list of one or more organizations and only third parties associated with those organizations may be provided with the phone number.

10. The method of claim 6, wherein the restricted group is a list of one or more organizations and only third parties associated with those organizations may be provided with the phone number.

11. A system for selectively providing information concerning wireless phone numbers, the system comprising:
a database which identifies the wireless phone numbers of a group of persons listed in the database and for each such wireless phone number maintains a profile indicating a set of conditions under which the wireless phone number can be provided to third parties;
means for examining the profile of each of the wireless phone numbers requested by a third party and providing the wireless phone number to the third party if the set of conditions associated with that wireless phone number have been met.

12. The system of claim 11, wherein the database is a single integrated database.

13. The system of claim 11, wherein the database is formed of a plurality of related databases.

14. The system of claim 11, wherein at least one of the conditions is that the phone number is published, indicating that the wireless phone number should be given to any third party making the request, and at least one other of the conditions is that the phone number is unpublished, indicating that the phone number should not be given to any third party making the request.

15. The system of claim 14, wherein at least one of the conditions is that there is a restricted group of third parties to whom the phone number may be provided.

16. The system of claim 11, wherein at least one of the conditions is that there is a restricted group of third parties to whom the phone number may be provided.

17. The system of claim 16, wherein the restricted group is a list of one or more individuals.

18. The system of claim 15, wherein the restricted group is a list of one or more individuals.

19. The system of claim 16, wherein the restricted group is a list of one or more organizations and only third parties associated with those organizations may be provided with the phone number.

20. The system of claim 15, wherein the restricted group is a list of one or more organizations and only third parties associates with those organizations may be provided with the phone number.

21. The system of claim 11, wherein the examining means is one or more programmed computers.
